(19) United States
(12) Patent Application Publication
(10) Pub. No.: US 2026/0259819 A1
(43) Pub. Date: Sep. 3, 2026

(54) DETECTING AND MITIGATING REGRESSIONS ASSOCIATED WITH CODE CHANGES

(71) Applicant: Microsoft Technology Licensing, LLC, Redmond, WA (US)

(72) Inventors: Akshay Navneetlal MUTHA, Sammamish, WA (US); Patrick Eugene MOULHAUD, Seattle, WA (US); Abhishek Anil KAKHANDIKI, San Jose, CA (US); Aditya Rajkumar MUNOT, Redmond, WA (US); Minjeong KIM, Bellevue, WA (US)

(21) Appl. No.: 19/067,237

(22) Filed: Feb. 28, 2025

(51) Int. Cl. G06F 11/362

(52) U.S. Cl. CPC G06F 11/3636

(57) ABSTRACT

The present disclosure relates to systems, methods, and computer-readable media for detecting and mitigation regression in a computer system. In particular, this disclosure relates to correlating changes to subroutines to log instances from a trace log and determining, based on these correlations, whether a subroutine or set of subroutines has caused a regression as a result of a change to the subroutine(s). The examples described herein involve determining which usage metrics are attributable to specific subroutine changes and detecting whether a regression has occurred. The disclosure further involves performing or causing to perform mitigation actions that reduce a negative impact of the regression as a result of the change(s) to the subroutine(s).

### BACKGROUND

A cloud computing system refers to a collection of computing devices capable of providing remote services and resources. For example, modern cloud computing infrastructures often include a collection of physical server devices organized in a hierarchical structure including computing regions, computing zones, node clusters, virtual local area networks (VLANs), racks, fault domains, etc. Cloud computing systems often make use of different types of virtual services (e.g., computing containers, virtual machines) that provide remote storage and computing functionality to various clients or customers. These virtual services can be hosted by server nodes on a cloud computing system.

Recent years have seen a rise in the use of cloud computing and other networked computing systems as well as a rise in complexity of the computing devices and applications running thereon. As these systems have grown in complexity, and as more and more services are being provided via the cloud, maintaining awareness or otherwise tracking inefficiencies and problems that are occurring with respect to various applications and/or devices has become increasingly difficult. Indeed, where a particular change causes a regression or other decline in performance of devices or applications on the cloud, identifying the cause of the regression of performance decline, or even the application or portion of code responsible for the regression, has become very difficult, even for experts in the relevant technologies.

Conventionally, these regressions and other negative impacts on the cloud require days or weeks of observation, often with trial and error approaches to determine root causes, often resulting in limited success in diagnosing the cause of the decreased performance(s). Indeed, conventional approaches involve kill switches, specialized tools, and flights to find regressions, meanwhile the decrease in performance as a result of the regression on the cloud computing system persists while these conventional diagnostic approaches are performed.

These and other difficulties exist in connection with accurately determining impact of changes in a computing environment (e.g., a cloud computing environment).

### BRIEF DESCRIPTION OF THE DRAWINGS

FIG. 1 illustrates an example environment of a computing system including a regression detection and mitigation system implemented on a server device in accordance with one or more embodiments.

FIG. 2 illustrates an example implementation of the regression detection and mitigation system in accordance with one or more embodiments.

FIG. 3 illustrates an example implementation in which the regression detection and mitigation system correlates change data and log data to present a visualization of a regression in accordance with one or more embodiments.

FIGS. 4A-4C illustrate example visualizations of potential regressions generated by the regression detection and mitigation system in accordance with one or more embodiments.

FIG. 5 illustrates an example series of acts for detecting a regression caused by an associated change to a sub-routine in accordance with one or more embodiments.

FIG. 6 illustrates certain components that may be included within a computer system.

### DETAILED DESCRIPTION

The present disclosure is related to methods and systems for detecting regressions caused as a result of implementing changes to code (e.g., subroutines) of various programs and applications that are operating on device(s) of a computing system. In particular, this disclosure involves maintaining a record of changes to subroutines and correlating utility metrics (e.g., computing costs) to instances of executions or other actions in which the subroutines are specifically utilized. These metrics are tracked over time and regressions are detected based on observed changes to the metrics over periods of time. In some implementations, mitigation actions are performed to remove or otherwise reduce the negative impact on the computing system(s) as a result of the detected regression. Indeed, as will be discussed below, the regression detection and mitigation system may perform these actions to improve resource utilization on a computing system, such as a cloud computing system or other network of computing devices that are running a variety of programs (e.g., software applications) thereon.

As an illustrative example, and as will be discussed in further detail below, a regression detection and mitigation system may register a commit identifier for a subroutine (or multiple subroutines) based on a change that has been made to a program including the subroutine. In one or more embodiments, this registration involves identifying portions of code (e.g., subroutine(s)) on which changes have been made and maintaining the record of a storage, such as a structured query language (SQL) server. The regression detection and mitigation system may obtain a trace log for a plurality of subroutines running on the computing system(s) where the trace log includes log instances indicating usage metrics (e.g., CPU usage, memory usage) for action instances in which the various subroutines are utilized.

Once the registration is performed and the combination of change data (e.g., commit identification, subroutine identifications) and log data are accessible, the regression detection and mitigation system can associate a set of log instances with commit identifiers for the subroutine(s) based on a comparison of the change data and the log data. As will be discussed below, costs identified in the trace log that are associated with specific commit identifiers can be observed overtime to determine whether a particular change to a subroutine is the cause or otherwise correlated with a regression on the computing system(s). In one or more embodiments, the regression detection and mitigation system may cause a mitigation action to the relevant subroutine(s) to be performed in an effort to reduce the cumulative cost of the usage metrics from the log instances.

The present disclosure includes a number of practical applications that provide benefits and/or solve problems associated with detecting and/or mitigating regressions that occur on a computing system as a result of one or more changes to various subroutines. Some non-limiting examples of these applications and benefits are discussed in further detail below.

By registering and storing data associated with a change (e.g., a change identifier and associated subroutine data), and then comparing the change data with information from a trace log, the regression detection and mitigation system provides a tool that enables correlation between one or more usage metrics (e.g., CPU usage, memory availability, volume of requests) with specific changes. Indeed, by storing this data in one or more storages to be compared with each obtained trace log, the regression detection and mitigation system facilitates correlating a change with usage metrics over an extended period of time even where the impact of a particular change does not impact availability of computational resources right away (e.g., at a time that a change is committed).

Further, by extracting subroutine and other change data associated with a commit identifier or other registered change, the regression detection and mitigation system not only correlates changes with specific computational costs of a trace log, but is able to identify specific subroutines that are associated with the usage metric data within a trace log. This is true even where a particular includes modifications to multiple subroutines. In this manner, the regression detection and mitigation system enables identification of specific portions of a change rather than simply correlating a series of multiple changes with a detected regression.

In one or more embodiments described herein, the trace log(s) are locally generated by each of multiple computing devices on a periodic basis (e.g., using a profiler application or other trace log generator function). By locally performing this action, this facilitates scalability of the methods described herein to the cloud or other large computing network, and providing an effective mechanism to track usage metric changes over time on a large scale. Indeed, it would be computationally prohibitive or even impossible to track change using a continual stream of trace logs or by running a trace log application from a centralized location, particularly where a computing network includes a prohibitively large number of computing device (such as a cloud computing system).

This periodic capturing of trace logs and log data generally additionally facilitates tracking of different types of usage metrics on a very granular scale. For example, as will be discussed below, a trace log may include a variety of usage metrics and associated portions of code to which the variety of usage metrics are attributed (e.g., as a result of the specific portions of code being called and indicated within the trace log). In this manner, regressions can be detected in connection with any number of different types of usage metrics that are contained within a trace log. This enables the regression detection and mitigation system to be applied to existing systems no matter the level of detail that a log data contains. Indeed, the methods and systems described herein may be applicable to older computing systems and networks which may include more rudimentary or less current types of usage metrics. The methods and systems described herein may similarly be applied to more modern and future generations of computing systems in which more complex and granular log data is (or will be) available.

In addition, by detecting regressions and pinpointing the portion(s) of code causing the regressions, the regression detection and mitigation system enables mitigation actions to be performed that can reduce processing costs while expanding availability of computational resources on a cloud computing system or other network of devices. For example, by generating an incident report, the regression detection and mitigation system provides a mechanism whereby a change can be modified or corrected to prevent further inefficiencies caused by the regression-causing code. As another example, by rolling back a change (or portion of a change), the regression detection and mitigation system can address computational efficiencies in a manner that frees up computing resources and improves the functionality of both the individual devices on which specific subroutines are executed as well as the cloud computing system as a whole. Indeed, because of the scalability of the systems and methods described herein as well as the variety of usage metrics that are tracked and correlated to specific subroutines, rolling back a single change (or a single portion of code of a change) can have a sizable impact on the availability of processing resources across a significant number of machines. This multiplies the benefits of computational efficiencies that features and functionality of the regression detection and mitigation system provide when applied on a large scale.

As illustrated in the foregoing discussion, the present disclosure utilizes a variety of terms to describe features and advantages of the systems described herein. Additional detail is now provided regarding the meaning of some example terms.

For example, as used herein, a “cloud computing system” refers to a network of connected devices that provide various services to clients (e.g., cloud clients, client devices, network devices). A cloud computing system may refer more generally to a distributed computing network (or system) that includes a collection of physical computing devices (e.g., server nodes) organized in a hierarchical structure. This hierarchical structure may include regions, zones, clusters, racks, or other groupings of server nodes (e.g., virtual local area networks, fault domains). While one or more embodiments described herein refer specifically to detecting and mitigating regressions on a cloud computing system, features described herein with respect to detecting and mitigating regressions may apply more generally to other distributed computing network or to individual computing devices. The cloud computing system may refer to a private or public cloud computing system.

As used herein, a “change” or “commit” may refer collectively to a modification that is applied to one or more portions of code of a program or other software application. In one or more embodiments described herein, a change refers to a change to a subroutine. A change may include multiple changes to a single subroutine or multiple changes applied to multiple subroutines. Thus, as used herein a commit identifier (or change identifier) may refer to a change that is inclusive of multiple modifications to one or more subroutines.

As used herein, a “trace log” is a record (or log) of actions that occur within a system, application, or process on a computing device. In one or more embodiments described herein, a trace log refers to a report that is generated on a periodic basis (e.g., by a profile application) in which a set of actions that have occurred over a period of time are logged and maintained on a computing device. A trace log includes a variety of log data including, by way of example, an identifier of a portion of code (e.g., a subroutine) that is called or otherwise invoked and one or more usage metrics applicable to the instance (e.g., log instance) in which the code is called or otherwise invoked. By way of example a trace log may include a set of subroutine identifiers and a plurality of usage metrics associated with each of the identifiers indicating computational usage by the computing device at the time the code is invoked. In one or more embodiments described herein the trace log may be represented by a graph or other visualization in which icons representing specific subroutines and usage metrics are included therein. Further examples of trace log data (or simply log data) will be discussed in connection with one or more embodiments described below.

As used herein, a “usage metric” or “cost” may refer interchangeable to a measure of utilization of a computational resource of a computing device or computing system. Indeed, a usage metric may refer to any measure of use of a resource that could or does affect the performance of a computing device. By way of example and not limitation, examples of usage metrics include a quantity of computing resources, a quantity of memory availability, and a quantity of requests that are sent or received by a device or program running on the device.

As used herein, a “regression” refers to a scenario in which a feature or system experiences a change in performance that reduces the availability of available resources on a computing device. For example, a regression may refer to an increased utilization of computational resources over a period of time such that the computing device on which the regression has occurred has less availability of computational resources prior to experiencing the regression. As another example, a regression may refer to a situation in which fewer memory resources are available the prior to occurrence of the regression. In one or more embodiments, a regression may refer to a combination of usage metrics declining or changing over a period of time or in an unexpected manner. Other examples of regressions or regression types are discussed herein. It will be appreciated that a regression is configurable and may be defined differently in different devices or systems or with respect to different applications or programs.

As used herein, a “mitigation action” refers to any action that can be taken by an individual or a device in which a regression is mitigated or otherwise reduced. For example, in one or more embodiments, a mitigation action is a generation of an incident report, which may include an identification of a regression and nay relevant information that would enable a system or administrator to mitigate the effects of the regression. As another example, in one or more embodiments, a mitigation action refers to a rollback action in which a subroutine or change is rolled back to a previous state prior to the regression occurring. Other examples of mitigation actions are discussed herein.

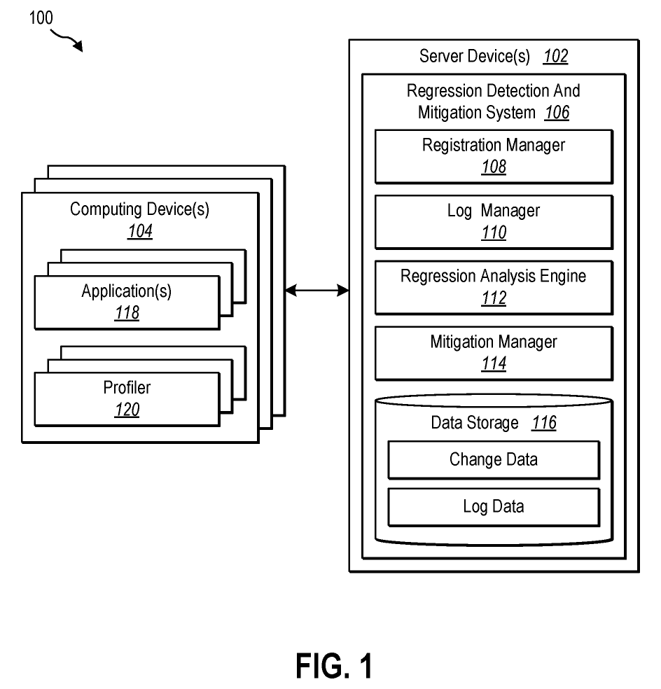

Additional detail will now be provided regarding systems described herein in relation to illustrative figures portraying example implementations. For example, FIG. 1 illustrates an example environment 100, which may refer to a network of computing devices or a cloud computing system. As shown in FIG. 1, the environment 100 includes a server device(s) 102 having a regression detection and mitigation system 106 implemented thereon.

As further shown, the environment 100 includes a plurality of computing device(s) 104 having one or more applications 118 running thereon. The application 118 may refer to a software application, program, or any process or sets of processes that are executable on a computing device. The computing device(s) 104 additionally includes a profiler 120 implemented thereon. The application(s) 118 and profiler 120 will be discussed in further detail below in connection with features and functionalities of the regression detection and mitigation system 106 on the server device(s) 102.

As just mentioned, and as shown in FIG. 1, the environment 100 includes computing devices 104 and one or more server device(s) 102. These respective devices may refer to various types of computing devices including, by way of example, mobile devices, desktop computers, server devices, Internet of Things (IoT) devices, edge network devices, or any other type of computing device capable of performing the features and functionalities described herein. For example, the computing devices 104 may refer to any computing device having a profiler 120 thereon that is capable of generating a log trace and storing the log trace in a data storage. Similarly, the server device(s) 102 may refer to a server node or other computing device on a computing network, such as a cloud computing system. These devices may communicate with one another over a network or multiple networks using any of a variety of communication platforms or technologies. Indeed, in one or more embodiments, the computing device(s) 104 and server device(s) 102 refer to devices that are both hosted on a cloud computing system. In one or more embodiments, the server device 102 is on a cloud computing system while the computing device(s) 104 are on a separate network or separate computing system.

Additional detail in connection with an example implementation of the regression detection and mitigation system 106 will be discussed below. Features described below in connection with respective components of the regression detection and mitigation system 106 may be applied to single or multiple device systems. For example, one or more embodiments of the regression detection and mitigation system 106 may be implemented on a single server device or across multiple server devices. As an example, one or more of the registration manager 108, log manager 110, regression analysis engine 112, or the mitigation manager 114 may be implemented on different server devices (e.g., of the same or different cloud computing system). Thus, while one or more embodiments described herein specifically refer to a regression detection and mitigation system 106 implemented on a single server device, it will be appreciated that features of the respective components may be implemented across multiple devices.

As noted above, the regression detection and mitigation system 106 includes a registration manager 108. The registration manager 108 may perform any action related to registering a change that has occurred with respect to an application on a computing device that is being monitored or otherwise observed by the regression detection and mitigation system 106 for the purpose of detecting and/or mitigating regressions.

In one or more embodiments, the registration manager 108 detects or otherwise receives a notification that a change has been made to an application or program (e.g., application 118). For example, an individual user or multiple users may modify a subroutine and/or create a subroutine and commit the modification to the application. Upon committing the change to the application, the notification of the change and/or the change itself can be provided to the registration manager 108.

Upon detecting that the change has occurred, the registration manager 108 may perform various acts related to registering the change. In one or more embodiments, the registration manager 108 registers the change by storing the commit identifier associated with the change in a storage. In one or more embodiments, this involves storing the commit identifier and any related change information (e.g., the changed application, the changed portion of the code) in a server storage, such as an SQL server.

In addition to storing the changed code and the change identifier (or any storage entry indicating that the relevant code has been changed), the registration manager 108 can extract code related to the change to identify any subroutines that are affected by the change to the application. In one or more embodiments, the registration manager 108 employs a tool that analyzes the code and extracts change information associated with the change identifier. In one or more embodiments, the registration manager 108 extracts the code and metadata to determine which portion of the code was changed as well as any relevant data associated with the change (e.g., an identity of the user who changed the code, a date when the change occurred, event data associated with the change, etc.). In one or more embodiments, the registration manager 108 extracts any information that may be used to identify which subroutines have been changed with respect to a particular commit identifier.

As noted in one or more embodiments described here, a change or commit may include a change to multiple subroutines from a plurality of subroutines (e.g., a collection of subroutines associated with an application or software product). In one or more embodiments, a change may refer to a change applied to a subset of subroutines from a collection of subroutines that run in connection with an application or set of applications. In this example, the registration manager 108 identifies the subset of subroutines to which the change has been made and stores the subroutine information together with the commit identifier. In this manner, each of the changed subroutines associated with a particular commit identifier may be identified in connection with a particular change as well as the changes that have been made to the various subroutines. This combined with the extract metadata and other related information may be used to detect regressions as well as information that may be helpful when troubleshooting or performing various mitigation actions.

In one or more embodiments, the registration manager 108 additionally registers event information associated with the commit identifier. For example, where an application that includes a changed subroutine is activated or opened or otherwise executed, or where any particular activity of the application activates a subroutine or causes a subroutine to be invoked (e.g., where a log instance would otherwise identify a subroutine in an activity log), the registration manager 108 registers identifiers of these events for purposes of recognized these events at a later time. Indeed, as will be discussed below, the registration manager 108 may store identifiers of these events in conjunction with the commit identifier to enable usage metrics from a log instance to be correlated with the commit identifier and/or any specific subroutine identifiers that are associated with the event(s).

As further shown in FIG. 1, the regression detection and mitigation system 106 includes a log manager 110. The log manager 110 may perform features related to obtaining a trace log and any associated log data for any number of applications and/or subroutines running on one or across a number of computing devices. In one or more embodiments, the log manager 110 collects trace logs for any number of applications, subroutines, and computing devices that are running on a cloud computing system (or other grouping of computing devices).

In one or more embodiments, the log manager 110 obtains a trace log for a plurality of subroutines running on a computing device. In one or more embodiments, the trace log includes any log data that is tracked in association with an application or multiple applications running on the computing device (e.g., computing device(s) 104). In one or more embodiments, the log manager 110 obtains trace logs from multiple computing devices running the same or different sets of applications and/or sets of subroutines thereon.

As indicated above, a trace log may include any number of log instances indicating actions that are executed by a computing device in which certain subroutines are called and which make use of a variety of computing resources. As used herein, a log instance refers to a specific event or instance in which a code or portion of code is invoked or otherwise called by the computing device (or application on the computing device). Thus, a trace log may include any number of log instances corresponding to a number of subroutines that are called, as well as a number of times that the respective subroutines are called, over a period of time.

It will be appreciated that the log data may of the trace log(s) may include a variety of types of data that are logged or otherwise tracked by a computing device. Non-limiting examples of data that may be included within a trace log (or within a particular log instance) include time stamps, event identifiers, descriptions of events, thread identifiers, user identifiers, subroutine identifiers, error codes transaction identifiers, and usage metrics. In one or more embodiments, different computing devices and different applications may be configured to collect different types and quantities of log data. In one or more embodiments, the type(s) of log data that are collected is configurable and may be modified from device to device (or from application to application).

As discussed above, the log data from the trace log(s) may be generated locally on the computing devices on which the application (and associated subroutines) are executed. For example, where a computing device includes a profiler 120 (e.g., a software tool configured to generate a profile log including any quantity of log data over a period of time), the profiler 120 may cause the computing device to generate a trace log including all tracked log data over a period of time (e.g., an hour, a day). In one or more embodiments, the profiler 120 is an application that is native to the computing device 104 and hardcoded or preconfigured to generate a trace log independent of the applications 118 running thereon. In one or more embodiments, the profile 120 is an installed software application including instructions that affect which trace data is collected and which data is included within a given trace log, which may differ from device to device.

In one or more embodiments, the log manager 110 collects the trace log(s) periodically over defined or otherwise predetermined periods of time. In one or more embodiments described herein, the computing device(s) 104 utilize a profiler 120 to generate a trace log once/day or once/hour (or other predefined period of time). The profile 120 would then automatically or, in response to a request, (e.g., from the log manager 110) provide the trace log(s) to the server device(s) 102 for further analysis.

In one or more embodiments, the log data includes usage metrics associated with resources that are used by a server device(s) 102 at a given moment in time associated with entries of the log data (e.g., log instances of a trace log). As noted above, the usage metrics may indicate usage statistics or other usage information associated with an operation or consumption of resources on the computing device(s) 104. In one or more embodiments, usage metrics are referred to as costs, such as computing costs, which refer to a quantity of computing resources that are expended or otherwise consumed when a particular code or portion of code is invoked. A usage metric may refer to a state of resources on the computing device at a particular moment in time (e.g., a timestamp of a log instance). In some instances, a usage metric refers to a quantity of resources that are attributable to invoking a specific subroutine or portion of code.

As noted above, usage metrics may encompass a variety of types of usage data. In some implementations, usage data refers to a quantity of computational usage, such as a quantity of processing or computing resources that are used by a computing device at a moment in time (or as a result of invoking a portion of code). In one or more embodiments, usage data refers to memory usage, such as a quantity of memory resources that are in use or that are available on a computing device (or to a specific application) at a particular moment or over a range of time. In one or more embodiments, usage data refers to a quantity of requests that are sent or received by a computing device (or based on instructions from an application). In one or more implementations, these requests refer specifically to external requests that are made in accordance with instructions from a subroutine or portion of code. It will be understood that these types of usage metrics are provided by way of example, and that the term “usage metrics” may include any statistic or measurement that is tracked and included in a trace log and which may affect performance of a computing device or computing system (e.g., a cloud computing system).

As further shown in FIG. 1, the regression detection and mitigation system 106 includes a regression analysis engine 112. As will be discussed in detail below, the regression analysis engine 112 evaluates log data and registration data (e.g., any data stored in connection with a commit identifier) to determine whether a regression has occurred.

In one or more embodiments, prior to determining whether a regression has occurred, the regression analysis engine 112 may associate log instances from a trace log with commit identifiers associated with a registered change. In one or more embodiments, the regression analysis engine 112 associates individual (or sets of) log instances from a trace log with a commit identifier for a subroutine based on a comparison of the registered commit identifier and the plurality of log instances from a trace log. As will be discussed in further detail below, the regression analysis engine 112 correlates specific log instances (e.g., instances in which individual or sets of subroutines are invoked) with the subroutine(s) associated with a commit identifier (e.g., as a result of extracting the subroutine identifier from the change code).

Associating the log instances with the commit identifier may be performed in a variety of ways. In one or more embodiments, the code extracted from the change, which includes an identifier of a subroutine, is correlated with identified subroutines from a generated trace log. The regression analysis engine 112 may determine, based on these matching subroutine identifiers, which log instances are associated with corresponding changes, which enables the regression analysis engine 112 to determine which usage metrics are associated with corresponding changes.

As noted above, in addition (or as an alternative) to associating changes generally with specific log instances, the log instances may be associated with specific portions of a change. For example, where a change or commit identifier is associated with changes to multiple subroutines (e.g., where multiple subroutines are changed as a result of a single commit), the regression analysis engine 112 may associate a log instance with a specific subroutine of a corresponding change. Indeed, the regression analysis engine 112 may associated a log instance with any of the information associated with a particular subroutine or change identifier, including metadata included as part of the change.

In correlating the change data associated with a registration with log instances from a trace log, the regression analysis engine 112 may compare stored change data to stored log data. It will be appreciated that the change data and log data may be maintained in a data storage 116 on or otherwise accessible to the server device(s) 102. In one or more embodiments, the respective data types (e.g., change data, log data) are maintained in a single storage (e.g., an SQL server). In other implementations, the log data and change data are maintained on separate storage spaces. Examples of each of these implementations are illustrated in connection with example embodiments described herein.

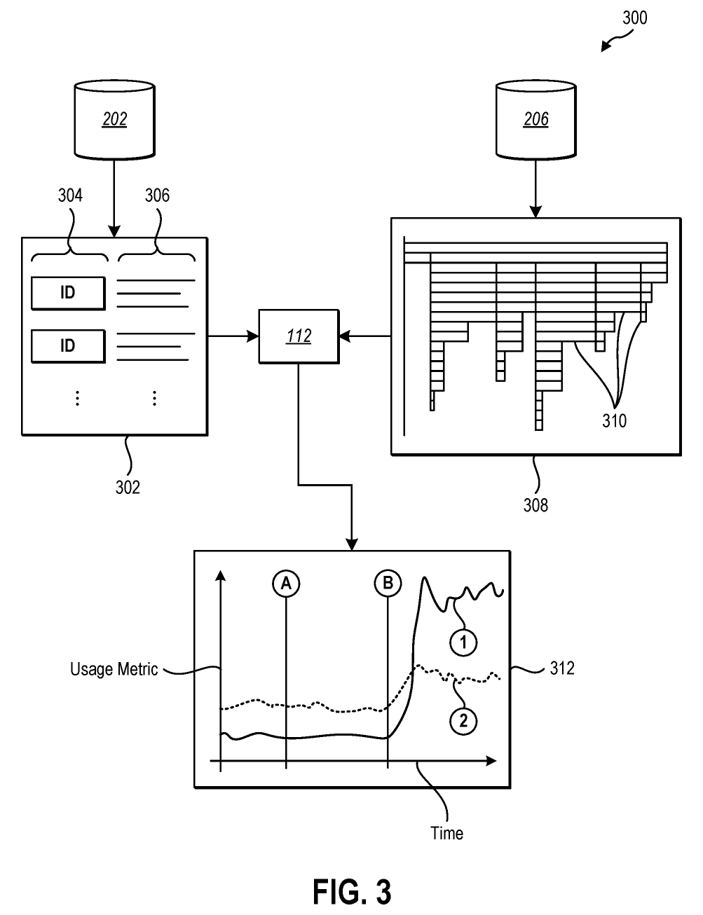

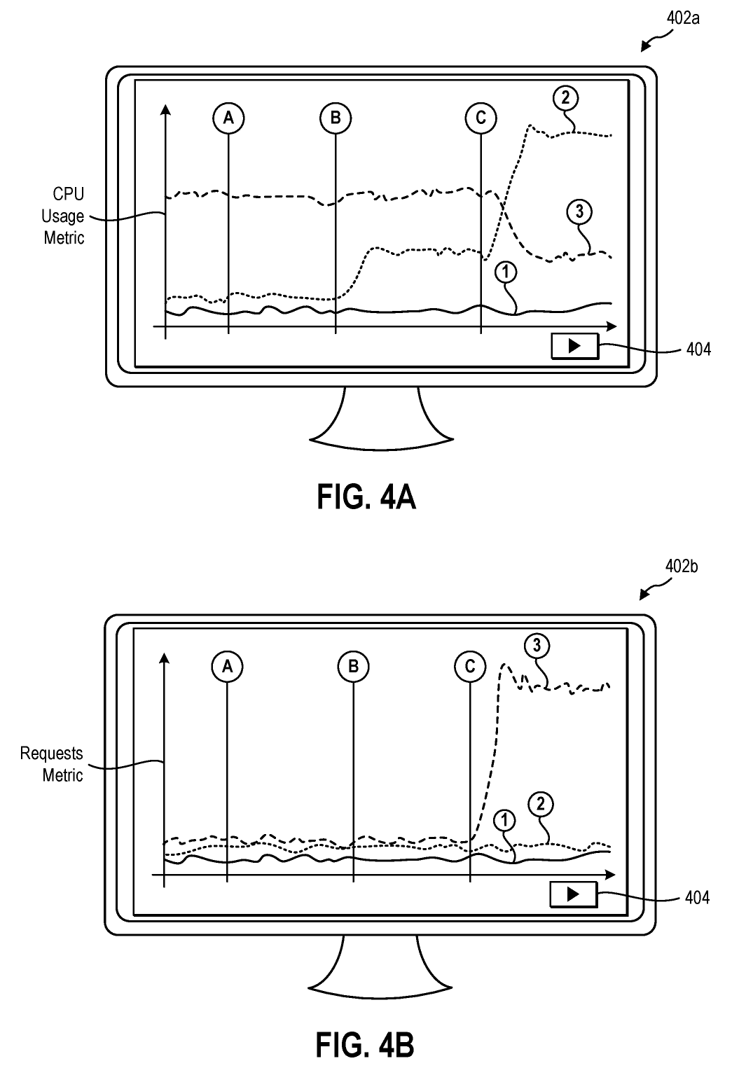

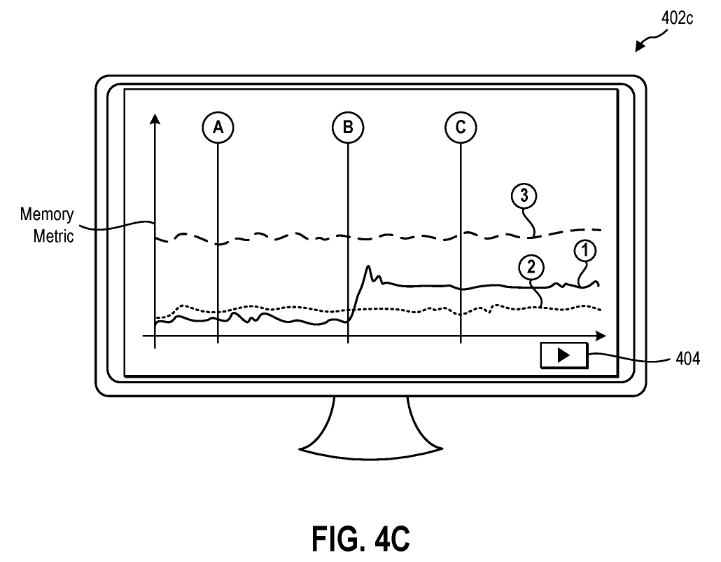

As noted above, the log data may include usage metrics associated with each of the log instances. For example, each log instance may include an indication of a quantity of computing resources (e.g., processing and/or storage resources), memory resources, requests, or other metric associated with consumption of resources on a computing device. In one or more embodiments, associated the log instances with the change identifier or with respective subroutine identifiers involves attributing costs or usage metrics to the subroutine identifiers that are indicated within the associated log instances. This association of the log instance with the corresponding change and/or subroutine identifiers will be discussed in further detail below (e.g., in connection with examples shown in FIGS. 3-4C.

In addition to correlating, matching, or otherwise associating log instance with subroutine identifiers (or more generally with commit identifiers), the regression analysis engine 112 may additionally analyze the usage metrics of the log instances to determined whether a regression has happened. In one or more embodiments, this involves analyzing a combination of usage metrics over time that are associated with a given commit identifier (or with a specific subroutine) to determine whether the combination of one or more tracked usage metrics over a given period of time qualifies as a regression.

In one or more embodiments, a regression is defined by one or more policies as one or more metrics that are associated with a potential decrease in performance of a computing device. More specifically, a regression may refer to a combination of one or more usage metrics indicating a greater than expected usage of computing resources over a period of time. In one or more embodiments, various types of regressions are defined based on thresholds of usage metrics over time. Additional detail in connection with examples of regressions will be discussed below in connection with illustrated examples.

As shown in FIG. 1, the regression detection and mitigation system 106 includes a mitigation manager 114. The mitigation manager 114 may perform a variety of actions based on a detected regression. In one or more embodiments, the mitigation manager 114 prompts generation of an incident report, which may indicate the commit identifier and/or specific subroutines of a change that are predicted to be causing the regression. The incident report may include any amount of information associated with the regression and usage metrics, which may be provided to an administrator or user in a position to perform one or more mitigation actions.

In another example, the mitigation manager 114 causes the computing device 104 to perform one or more actions that mitigate the regression. For example, in one or more embodiments, the mitigation manager 114 causes the computing device(s) 104 to roll back one or more portions of a commit to restore one or more subroutines to a previous state prior to the change or prior to occurrence of the regression. This rollback may be a rollback of an entire change or, alternatively, roll back of a portion of a change to a particular subroutine that is determined to be causing the regression.

It will be appreciated that the mitigation manager 114 may determine a mitigation action based on a variety of factors. For example, the mitigation manager 114 may determine to perform a particular mitigation action based on the type of usage metric that has increased. Indeed, an increase in quantity of computing resources that are consumed as a result of executing a subroutine may be associated with a different mitigation action than an increase in requests that are received or transmitted by a computing device. It will be appreciated that the mitigation manager 114 may be configured to perform any of a variety of mitigation actions as may serve a particular scenario (e.g., a type of regression).

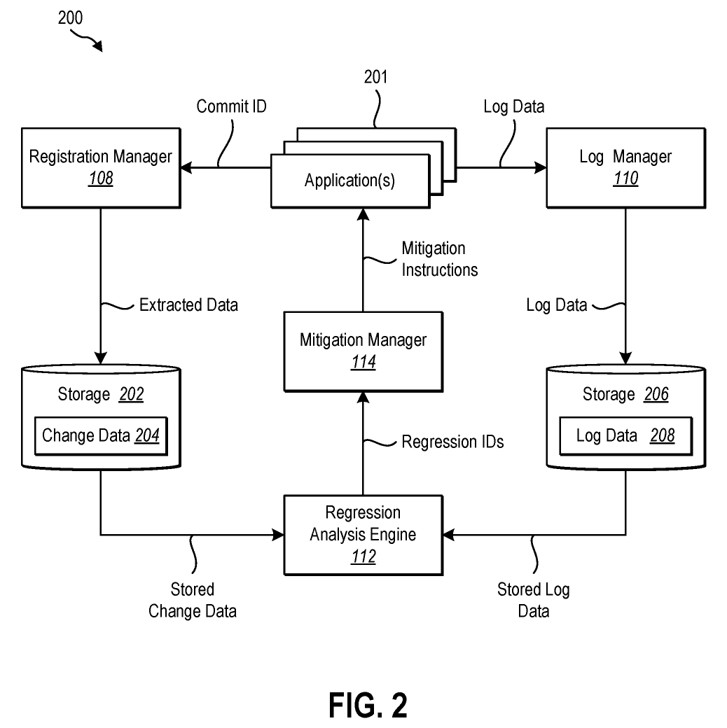

As noted above, the regression detection and mitigation system 106 includes a data storage 116. The data storage 116 includes a variety of data types maintained thereon and which can be made accessible to any of the subcomponents 108-114 of the regression detection and mitigation system 106. Examples of data include change data and log data. It will be appreciated that the change data and log data may be maintained in separate storages (e.g., as shown in FIG. 2 below) or may be maintained within a single data storage 116 (e.g., as shown in FIG. 1). Indeed, the data storage 116 may refer to any storage having data maintained thereon that is accessible to components 108-114 of the regression detection and mitigation system 106 to accomplish any of the features and functionality described herein.

Moving on, FIG. 2 illustrates an example workflow 200 including features and functionalities of a regression detection and mitigation system 106 as discussed above in connection with FIG. 1. In particular, FIG. 2 illustrates a workflow in which the regression detection and mitigation system 106 (having similar features as discussed above in connection with FIG. 1) obtains change data and log data to detect and mitigate one or more regressions that occur across one or more applications 201. These applications 201 may refer to applications across any number of computing devices (e.g., such as server nodes of a cloud computing system) in a variety of computing environments.

As shown in FIG. 2, a change is applied to code of the applications 201. In response to the code being modified or otherwise changed, the regression detection and mitigation system 106 may obtain change information including a commit identifier. As shown in FIG. 2, a commit identifier may be provided to the registration manager 108 as part of a change registration process. As noted above, a commit identifier may be associated with any number of changes to one or more subroutines that are part of the applications 201.

As part of the registration process, the regression detection and mitigation system 106 may extract code of the commit identifier by extracting code from the associated change. In one or more embodiments, this involves using a tool (e.g., a code extraction tool) to extract code and associated metadata for an associated change to identify subroutines, user data, and any other information associated with a commit identifier. As shown in FIG. 2, the registration manager 108 may store the extracted data (and the associated commit identifier) on a storage 202. The data that is stored (e.g., inclusive of the commit identifier, the extracted data, and any other information associated with a registration) may be referred to as change data 204.

In addition to registering the change, the regression detection and mitigation system 106 may further collect or otherwise obtain log data associated with the applications 201. For example, as shown in FIG. 2, the log manager 110 may obtain log data in the form of log traces that are locally generated by computing devices on which the applications 201 are running. In one or more embodiments, the log manager 110 obtains periodic chunks of log data, such as log traces inclusive of all tracked log data for a computing device (or in association with a particular application) that is tracked by the computing device over a predetermined period of time (e.g., one day).

As shown in FIG. 2, similar to the change data 204, the log data may be maintained in a storage 206. As noted above, the log data may include usage metrics and any other information that is tracked by the computing devices with regard to executing or running the applications 201 thereon. In this example, the tracked data, including any information that is contained within the obtained trace logs, is referred to as log data 208, which can be maintained in the storage 206. It will be appreciated that while the respective storages 202, 206 are shown as separate, in one or more embodiments, these storages 202, 206 refer to a shared storage on which the change data 204 and log data 208 may be maintained.

As shown in FIG. 2, the regression detection and mitigation system 106 may compare the stored change data and the stored log data to determine correlations between the two collections of data. In particular, as shown in FIG. 2, the regression analysis engine 112 may compare the different sources of data to determine correlations between specific commit identifiers (and associated subroutine identifiers) from the change data 204 and the usage metrics that are contained within log instances of the log data 208.

As noted above, the regression detection and mitigation system 106 may determine whether one or more regressions have occurred within the stored log data. More specifically, the regression detection and mitigation system 106 may determine whether one or more regressions have occurred and whether the regression(s) are attributable to one or more changes that have been made with respect to a commit identifier (and/or specific subroutine identifier).

As noted above, determining a regression may be based on an observation of the log data over time. For example, in one or more embodiments, a regression is determined based on an increase in one or more usage metrics has occurred over a predetermined period of time. For instance, where the log data includes trace logs that are obtained daily, a regression may be based on an increase in resource utilization over a three day period of time in which the quantity of increased resource utilization exceeds a threshold increase in usage. Some specific examples of observed increases in usage metrics that are determined to correspond to detected regressions will be discussed below in connection with FIGS. 4A-4C.

As shown in FIG. 2, where the regression detection and mitigation system 106 determines that a regression has occurred, the regression detection and mitigation system 106 may generate and provide a regression identifier to an entity tasked with mitigating the regression. More specifically, as shown in FIG. 2, the regression analysis engine 112, upon comparing the stored change data and stored log data to identify a regression, may generate and provide a regression identifier (and any associated regression data) to the mitigation manager 114 for one or more further actions related to addressing the regression.

In this example, the mitigation manager 114 generates mitigation instructions and executes one or more actions on the applications 201. In one or more embodiments, the mitigation instructions include an incident report that is used to apply one or more mitigation actions to the applications 201. In one or more embodiments, the mitigation instructions include instructions to roll back deployment of the applications 201 (and/or specific subroutines) to a previous state prior to applying a change to the application 201. In one or more embodiments, the mitigation instructions halt execution of the applications 201 (or uninstall an application or subroutine) for a period of time while the change is further analyzed or further modified to address the potential causes of the regression. Other implementations may involve different instructions that lead to different mitigations actions either by individuals or computing devices capable of modifying the applications 201 and otherwise addressing the detected regression(s).

It will be appreciated that FIGS. 1-2 illustrate example implementations of a regression detection and mitigation system 106 including a flow of data that may pass between components of the regression detection and mitigation system 106. In one or more embodiments, the regression detection and mitigation system 106 may refer to a single entity on a single server device that is configured to perform each of the features and functionality described in connection with the various components 108-114 of the regression detection and mitigation system 106. Alternatively, the regression detection and mitigation system 106 may include any of the discrete features or functionalities of the various components across multiple devices (e.g., multiple server devices of a cloud computing system) to perform acts of the different embodiments described herein.

FIG. 3 illustrates additional details in connection with a portion of the workflow 200 discussed above in FIG. 2. More specifically, FIG. 3 illustrates an example workflow 300 in which a commit identifier entry 302 is compared against a profile map 308 to determine correlations between a change and usage metrics of a trace log. In one or more embodiments, the commit identifier entry 302 is an example of the change data 204 stored on a first storage 202, which may store any number of commit identifier entries and associated change data. In one or more embodiments, the profile map 308 refers to a trace log including any quantity of log data 208 from the second storage 206. A separate profile map 308 may be generated for each computing device on which an application is running, and may provide log data associated with any number of applications running on a given computing device.

As shown in FIG. 3, a commit identifier entry 302 may include one or more identifiers 304. These identifiers may refer to commit identifiers that are associated with a change as a whole. In or more of these identifiers may refer to subroutine identifiers that are associated with individual subroutines from a plurality of subroutines that have been modified by a particular change.

In addition to the respective identifiers, the commit identifier entry 302 may include additional change data 306 including any information related to a respective identifier. For example, the additional change data 306 may include metadata associated with a particular change or particular subroutine. In one or more embodiments, the additional change data 306 includes event information, such as event identifiers associated with different stages of use of a particular subroutine (e.g., a commit event, an execution event, or other phase of when an application or subroutine would be activated or otherwise utilized on a computing device).

As further shown in FIG. 3, a profile map 308 may include any number of log instance icons 310 indicating events in which particular subroutines are invoked by the computing device on which one or more applications are running. In this example, the profile map 308 includes any number of identified subroutines along a timeline indicating instances when one or more subroutines are invoked or otherwise called on in a way that utilizes computing resources of a computing device.

As shown in FIG. 3, the data from the commit identifier entry 302 and the data from the profile map 308 may be compared to determine matches or associations between the identifiers 304 from the change data 204 and the log instances 310 from the profile map 308. As noted above, these correlations may be determined based on information that is extracted from a particular change (e.g., subroutine identifiers and associated event data) being compared against subroutine identifiers from within the profile map 308.

After these correlations are determined, the regression detection and mitigation system 106 may generate a usage metric visualization 312. As shown in FIG. 3, this usage metric visualization 312 shows an example visualization of a usage metric over time as it pertains to a commit identifier. In this example, the usage metric visualization 312 shows an example visualization in which a usage metric of a first subroutine (denoted by the numeral ‘1’) is shown over a period of time and with relation to tracked events (denoted as ‘A’ and ‘B’). The usage metric visualization 312 further shows an example visualization in which the usage metric of a second subroutine (denoted by the numeral ‘2’) is shown over the same period of time and with relation to the tracked events ‘A’ and ‘B’.

As shown in the illustrated usage metric visualization 312, a first event (event ‘A’) occurs and has minimal impact on the usage metric for the first and second subroutines. Upon occurrence of a second event (event ‘B’), utilization of the computing resource associated with the usage metric spikes for both the first and second subroutines. More specifically, the usage metric associated with the first subroutine spikes significantly while the usage metric associated with the second subroutine increases slightly.

In this example, the regression detection and mitigation system 106 may consider a variety of factors to determine whether a regression has occurred based on the data indicated within the usage metric visualization 312. For example, the regression detection and mitigation system 106 may determine that change to the first subroutine is causing a regression as a result of an increase in the usage metric by a specific quantity or percentage between an initial state (e.g., at time = 0) and a state after the second event. In this example, the regression detection and mitigation system 106 may determine that the second subroutine is not causing a regression due to the slight increase of the usage metric being less than some predetermined threshold.

In one or more embodiments, the regression detection and mitigation system 106 determines whether a regression has occurred based on a combination of an increase in usage metrics for subroutines associated with a commit identifier. For example, in this usage metric visualization 312, the regression detection and mitigation system 106 may consider a combination of the increase in the usage metric between both the first subroutine and the second subroutine to determine that a regression has occurred. Thus, any mitigation action may involve actions taken with respect to both the first subroutine and the second subroutine.

FIGS. 4A-4C illustrate a series of additional usage metric visualizations 402a-c that may be produced by a regression detection and mitigation system 106 in accordance with one or more embodiments. As will be discussed below, each of the usage metric visualizations 402a-c may include a visualization of different usage metrics over time with respect to a set of subroutines and across multiple tracked events.

It will be appreciated that the usage metrics that are visualized over FIGS. 4A-4C relate to a common commit identifier that involves changes to three subroutines. As will be discussed below, each of the visualizations show tracked usage metrics of different usage metric types over a period of time as they relate to the commit identifier. Each of these visualizations are provided by way of example only, and may include additional or fewer subroutines, additional or fewer events, and additional or fewer tracked usage metrics as may serve a particular implementation of the regression detection and mitigation system 106.

As a first example, FIG. 4A illustrate a first usage metric visualization 402a including a visualization of a CPU usage metric over a period of time with respect to a set of three subroutines (denoted as subroutines ‘1’, ‘2’, and ‘3’) and over a period of time that includes three tracked events (denoted as events ‘A’, ‘B’, and ‘C’). In this example, the usage metric refers to a CPU usage metric, which may involve a quantity of computing resources that are indicated in a trace log and attributable to specific subroutines involved in a change.

As shown in the first usage metric visualization 402a, the CPU usage metric is unaffected for a first subroutine (subroutine ‘1’) throughout occurrence of each of the events A-C. In contrast, the CPU usage metric for a second subroutine (subroutine ‘2’) sees a slight increase after occurrence of the second event (Event ‘B’) followed by a spike in the CPU usage metric after occurrence of the third event (Event ‘C’). As further shown, the CPU usage metric for the third subroutine (subroutine ‘3’) sees a steady rate and then decreases after occurrence of the third event.

In this example, similar to the example discussed above in connection with FIG. 3, the regression detection and mitigation system 106 may determine that a regression has occurred (or has not occurred) based on an analysis of the CPU usage metric over time. In one or more embodiments, the regression detection and mitigation system 106 determines that a regression has occurred based on threshold increases of the individual CPU usage metric as it pertains to a specific subroutine. For example, the regression detection and mitigation system 106 may determine a regression has occurred based on the CPU usage metric increasing for the second subroutine by a threshold amount. In one or more embodiments, the regression detection and mitigation system 106 determines that a regression occurs (or does not occur) based on a combination of CPU usage metrics. For example, where the CPU usage metric increases for the second subroutine, but decreases for the third subroutine, the regression detection and mitigation system 106 may determine that the metrics offset and that a regression that may have a detrimental affect on the computing device has not occurred.

In one or more embodiments, one particular usage metric may increase while other metrics may decrease (or remain the same). This is shown in the second usage metric visualization 402b shown in FIG. 4B. In this example, a request metric (e.g., a quantity of requests made based on the subroutines associated with a commit identifier) sees no change for the first and second subroutines, but sees a substantial increase with respect to the third subroutine. In this example, the regression detection and mitigation system 106 may determine a regression based on the increase of requests exceeding a threshold amount or percentage over the observed period of time.

As a further example, a third usage metric visualization 402c is shown including a visualization of a memory metric (e.g., a quantity of available or expended memory resources on a computing device) for each of the subroutines of the change over time. In this example, the second and third subroutines see no change over time to availability or consumption of memory usage as a result of calls to the second or third subroutines. In contrast, the memory metric sees a slight increase in the memory metric after occurrence of the second event (Event ‘B’).

As noted above, the regression detection and mitigation system 106 may determine whether a regression has occurred based on a usage metric for a subroutine or based on a combined metric over multiple subroutines. Similarly, in one or more embodiments, the regression detection and mitigation system 106 may determine whether a regression has occurred based on a combination of different types of usage metrics for a specific subroutine. In one or more embodiments, the regression detection and mitigation system 106 determines whether a regression has occurred based on a combination of different types of usage metrics across multiple subroutines.

In the example usage metric visualizations 402a-c shown in FIG. 4C, the visualizations are provided via graphical user interfaces of a computing device. As shown in the respective usage metric visualizations 402a-c, one or more icons may enable a user of the computing device to see the different visualizations. For example, as shown in FIGS. 4A-4C, each of the usage metric visualizations 402a-c include a toggle icon 404 that allows an individual to toggle between the different views and see the different types of metrics with respect to the subroutines. While not shown in FIGS. 4A-4C, other views may include a display of different usage metrics for an individual subroutine, or a combination of multiple metrics with respect to multiple subroutines.

In each of the views, an individual may gain further insight as to the affect that a particular change makes to a computer system as a whole. In one or more embodiments, a user may view a visualization based on a rollback of a particular subroutine or combination of multiple subroutines to view the impact on one or more usage metrics where one or more subroutines are no longer being called. It will be appreciated that these visualizations are provide by way of example, and may include any number of visualizations that may be filtered or toggled using various icons.

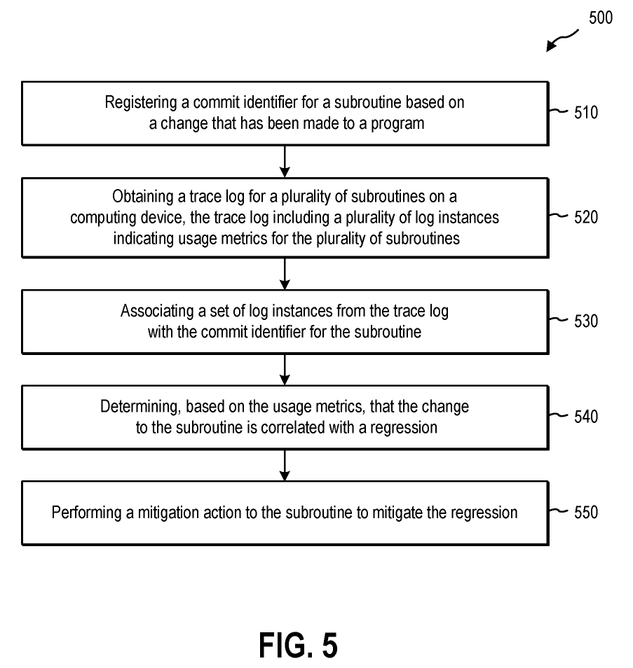

Turning now to FIG. 5, this figure illustrates an example flowchart including a series of acts for detecting and mitigating a regression on one or more computing devices as a result of a change or commit to an application or portion of code(s). While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device (e.g., a server device) to perform the acts of FIG. 5. In still further embodiments, a system can perform the acts of FIG. 5.

FIG. 5 illustrates a series of acts 500 relates to detecting and mitigating one or more regressions on computing device(s) as a result of a change or commit to an application or subroutine. As shown in FIG. 5, the series of acts 500 includes an act 510 of registering a commit identifier for a subroutine based on a change that has been made to a program. In one or more embodiments, the act 510 includes registering a commit identifier for a subroutine based on a change that has been made to a program including the subroutine.

The series of acts 500 additionally includes an act 520 of obtaining a trace log for a plurality of subroutines on a computing device, the trace log including a plurality of log instances indicating usage metrics for the plurality of subroutines. In one or more embodiments, the act 520 includes obtaining a trace log for a plurality of subroutines running on one or more computing systems, the trace log including a plurality of log instances indicating usage metrics for action instances of the plurality of subroutines.

As further shown, the series of acts 500 includes an act 530 of associating a set of log instances from the trace log with the commit identifier for the subroutine. In one or more embodiments, the act 530 includes an act of associating a set of log instances from the trace log with the commit identifier for the subroutine based on a comparison of the registered commit identifier and the plurality of log instances from the trace log.

As further shown, the series of acts 500 includes an act 540 of determining, based on the usage metrics, that the change to the subroutine is correlated with a regression. In one or more embodiments, the act 540 includes an act of determining, based on the usage metrics of the set of log instances that are associated with the commit identifier for the subroutine, that the change to the subroutine is correlated with a regression on the one or more computing systems.

As further shown, the series of acts 500 includes an act 550 of performing a mitigation action to the subroutine to mitigate the regression. In one or more embodiments, the act 550 includes an act of performing a mitigation action to the subroutine to mitigate the regression and reduce a cumulative cost of the usage metrics of the associated log instances.

In one or more embodiments, registering the commit identifier includes extracting information associated with the subroutine from a program based on the change that has been made to the program. In one or more embodiments, registering the commit identifier includes maintaining a commit entry within a storage associated with the commit identifier, the commit entry including an identifier of the subroutine extracted from the program and one or more event identifiers associated with usage events that can be detected in connection with executing the subroutine.

In one or more embodiments, the usage metrics include a quantity of computing resources in use by the one or more computing systems. In one or more embodiments, the usage metrics include a quantity of memory availability on the one or more computing systems. In one or more embodiments, the usage metrics include a quantity of requests sent or received by the one or more computing systems. In one or more embodiments, determining that the change to the subroutine is correlated with the regression includes determining that the usage metric has exceeded a threshold usage metric over a predetermined period of time.

In one or more embodiments, obtaining the trace log involves generating a log report on each of the one or more computing systems on a periodic basis, and wherein determining that the change to the subroutine is correlated with the regression is based on changes to the usage metrics over a predetermined period of time. In one or more embodiments, determining that the first subroutine is correlated with the regression is performed without determining that one or more additional subroutines of the two or more subroutines are correlated with the regression on the one or more computing systems.

In one or more embodiments, performing the mitigation includes causing the subroutine to roll back to a previous state prior to applying the change to the subroutine. In one or more embodiments, performing the mitigation of the regression includes generating an incident report including the usage metrics and event data associated with the subroutine over a predetermined period of time for which the set of log instances is obtained.

In one or more embodiments, the computing systems are server devices of a cloud computing system running the program thereon. Further, in one or more embodiments, the plurality of subroutines are subroutines executed by the program running on the server devices of the cloud computing system.

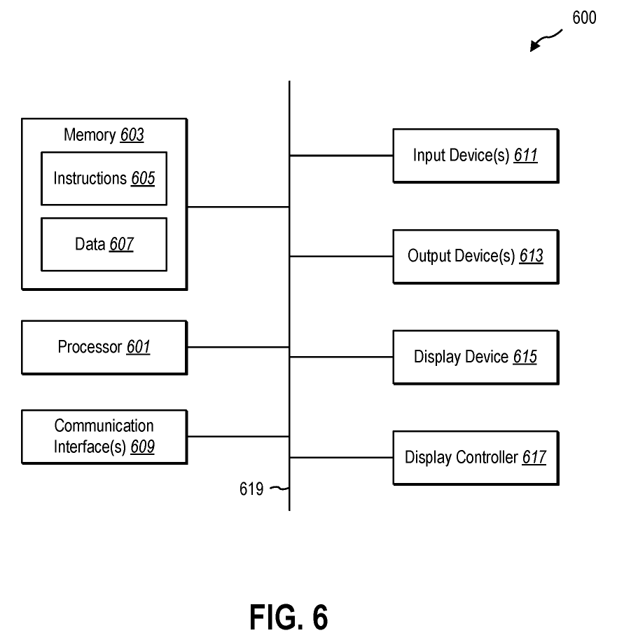

FIG. 6 illustrates certain components that may be included within a computer system 600. One or more computer systems 600 may be used to implement the various devices, components, and systems described herein.

The computer system 600 includes a processor 601. The processor 601 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth^{®} wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a distributed computing network environment in which computing resources are executing subroutines, a method for mitigating regressions caused by code changes, the method comprising:
registering a commit identifier for a subroutine based on a change that has been made to a program including the subroutine;
obtaining a trace log for a plurality of subroutines running on one or more computing systems, the trace log including a plurality of log instances indicating usage metrics for action instances of the plurality of subroutines;
associating a set of log instances from the trace log with the commit identifier for the subroutine based on a comparison of the registered commit identifier and the plurality of log instances from the trace log;
determining, based on the usage metrics of the set of log instances that are associated with the commit identifier for the subroutine, that the change to the subroutine is correlated with a regression on the one or more computing systems; and
performing a mitigation action to the subroutine to mitigate the regression and reduce a cumulative cost of the usage metrics of the associated log instances.

2. The method of claim 1, wherein registering the commit identifier includes extracting information associated with the subroutine from a program based on the change that has been made to the program.

3. The method of claim 2, wherein registering the commit identifier includes maintaining a commit entry within a storage associated with the commit identifier, the commit entry including an identifier of the subroutine extracted from the program and one or more event identifiers associated with usage events that can be detected in connection with executing the subroutine.

4. The method of claim 1, wherein the usage metrics include a quantity of computing resources in use by the one or more computing systems.

5. The method of claim 1, wherein the usage metrics include a quantity of memory availability on the one or more computing systems.

6. The method of claim 1, wherein the usage metrics include a quantity of requests sent or received by the one or more computing systems.

7. The method of claim 1, wherein determining that the change to the subroutine is correlated with the regression includes determining that the usage metric has exceeded a threshold usage metric over a predetermined period of time.

8. The method of claim 1, wherein obtaining the trace log involves generating a log report on each of the one or more computing systems on a periodic basis, and wherein determining that the change to the subroutine is correlated with the regression is based on changes to the usage metrics over a predetermined period of time.

9. The method of claim 1, wherein performing the mitigation includes causing the subroutine to roll back to a previous state prior to applying the change to the subroutine.

10. The method of claim 1, wherein performing the mitigation of the regression includes generating an incident report including the usage metrics and event data associated with the subroutine over a predetermined period of time for which the set of log instances is obtained.

11. The method of claim 1, wherein the computing systems are server devices of a cloud computing system running the program thereon, wherein the plurality of subroutines are subroutines executed by the program running on the server devices of the cloud computing system.

12. In a computing environment in which computing resources are executing subroutines, a method for mitigating recessions caused by code changes, the method comprising:
registering a commit identifier based on a change that has been made to two or more subroutines of a program;
obtaining a trace log for a plurality of subroutines running on one or more computing systems, the trace log including a plurality of log instances indicating usage metrics for action instances of the plurality of subroutines;
associating log instances from the trace log with the two or more subroutines based on a comparison of the registered commit identifier and the plurality of log instances from the trace log;
determining, based on the usage metrics of the log instances that are associated with the commit identifier, that a first subroutine of the two or more subroutines is correlated with a regression on the one or more computing systems; and
performing a mitigation action to the first subroutine to mitigate the regression and reduce a cumulative cost of the usage metrics of the associated log instances.

13. The method of claim 12, wherein registering the commit identifier includes extracting information from the plurality of subroutines to identify the two or more subroutines associated with the change.

14. The method of claim 13, wherein registering the commit identifier includes maintaining a commit entry within a storage associated with the commit identifier, the commit entry including identifiers of the two or more subroutines extracted from the program and one or more event identifiers associated with usage events that can be detected in connection with executing the two or more subroutines.

15. The method of claim 13, wherein the usage metrics include one or more of:
a quantity of computing resources in use by the one or more computing systems;
a quantity of memory availability on the one or more computing systems; and
a quantity of requests sent or received by the one or more computing systems.

16. The method of claim 13, wherein determining that the first subroutine is correlated with the regression is performed without determining that one or more additional subroutines of the two or more subroutines are correlated with the regression on the one or more computing systems.

17. The method of claim 13, wherein performing the mitigation includes causing the first subroutine to roll back to a previous state prior to applying the change to the first subroutine.

18. The method of claim 17, wherein the first subroutine is rolled back without causing one or more additional subroutines of the two or more subroutines to roll back to the previous state prior to applying the change to the two or more subroutines.

19. A system, comprising:
at least one processor;
memory in electronic communication with the at least one processor; and
instructions stored in the memory, the instructions being executable by the at least one processor to:
register a commit identifier for a subroutine based on a change that has been made to a program including the subroutine;
obtain a trace log for a plurality of subroutines running on one or more computing systems, the trace log including a plurality of log instances indicating usage metrics for action instances of the plurality of subroutines;
associate a set of log instances from the trace log with the commit identifier for the subroutine based on a comparison of the registered commit identifier and the plurality of log instances from the trace log;
determine, based on the usage metrics of the set of log instances that are associated with the commit identifier for the subroutine, that the change to the subroutine is correlated with a regression on the one or more computing systems; and
perform a mitigation action to the subroutine to mitigate the regression and reduce a cumulative cost of the usage metrics of the associated log instances.

20. The system of claim 19, wherein registering the commit identifier includes extracting information associated with the subroutine from a program based on the change that has been made to the program, and wherein registering the commit identifier includes maintaining a commit entry within a storage associated with the commit identifier, the commit entry including an identifier of the subroutine extracted from the program and one or more event identifiers associated with usage events that can be detected in connection with executing the subroutine.
